(19) United States
(12) Patent Application Publication
(10) Pub. No.: US 2018/0034639 A1
(43) Pub. Date: Feb. 1, 2018

(54) MULTIPLE CREDENTIALS FOR MITIGATING IMPACT OF DATA ACCESS UNDER DURESS

(71) Applicant: International Business Machines Corporation, Armonk, NY (US)

(72) Inventor: Jason K. Resch, Chicago, IL (US)

(21) Appl. No.: 15/728,276

(22) Filed: Oct. 9, 2017

Related U.S. Application Data
(63) Continuation-in-part of application No. 13/588,286, filed on Aug. 17, 2012, now Pat. No. 9,785,491.
(60) Provisional application No. 61/542,923, filed on Oct. 4, 2011.

(51) Int. Cl. H04L 9/32; G06F 11/10

(52) U.S. Cl. CPC H04L 9/3236; G06F 11/1076; H04L 9/3263

(57) ABSTRACT

A method includes generating a first plurality of representations of data. The method further includes encrypting the representations of the data using a plurality of access credentials to produce a plurality of encrypted representations of the data. The method further includes dispersed storage error encoding the encrypted representations of the data to produce set(s) of encoded data slices. The method further includes generating integrity data from the plurality of access credentials. The method further includes appending the integrity data to each encoded data slice of the set(s) of encoded data slices to produce set(s) of appended encoded data slices. The method further includes encrypting the set(s) of appended encoded data slices using a password to produce set(s) of encrypted encoded data slices. The method further includes sending the set(s) of encrypted encoded data slices to a set of storage units for storage therein.

### CROSS-REFERENCE TO RELATED APPLICATIONS

This application claims priority pursuant to 35 U.S.C. §120, as a continuation-in-part (CIP) of U.S. Utility patent application Ser. No. 13/588,286, entitled “PROCESSING A CERTIFICATE SIGNING REQUEST IN A DISPERSED STORAGE NETWORK,” filed Aug. 17, 2012, issuing as U.S. Pat. No. 9,785,491 on Oct. 10, 2017, which claims priority pursuant to 35 U.S.C. §119(e) to U.S. Provisional Application No. 61/542,923, entitled “STORING PASSWORDS IN A DISPERSED CREDENTIAL STORAGE SYSTEM,” filed Oct. 4, 2011, expired, both of which are hereby incorporated herein by reference in their entirety and made part of the present U.S. Utility patent application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This invention relates generally to computer networks and more particularly to mitigating adverse exposure of data in such networks.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a logic block diagram of an embodiment of utilizing credentials in a DSN in accordance with the present invention;

FIG. 10 is a schematic block diagram of an example of utilizing credentials in a DSN in accordance with the present invention;

FIG. 11 is a schematic block diagram of another example of utilizing credentials in a DSN in accordance with the present invention;

FIG. 12 is a schematic block diagram of another example of utilizing credentials in a DSN in accordance with the present invention;

FIG. 13 is a schematic block diagram of another example of utilizing credentials in a DSN in accordance with the present invention; and

FIG. 14 is a schematic block diagram of another example of utilizing credentials in a DSN in accordance with the present invention.

### DETAILED DESCRIPTION OF THE INVENTION

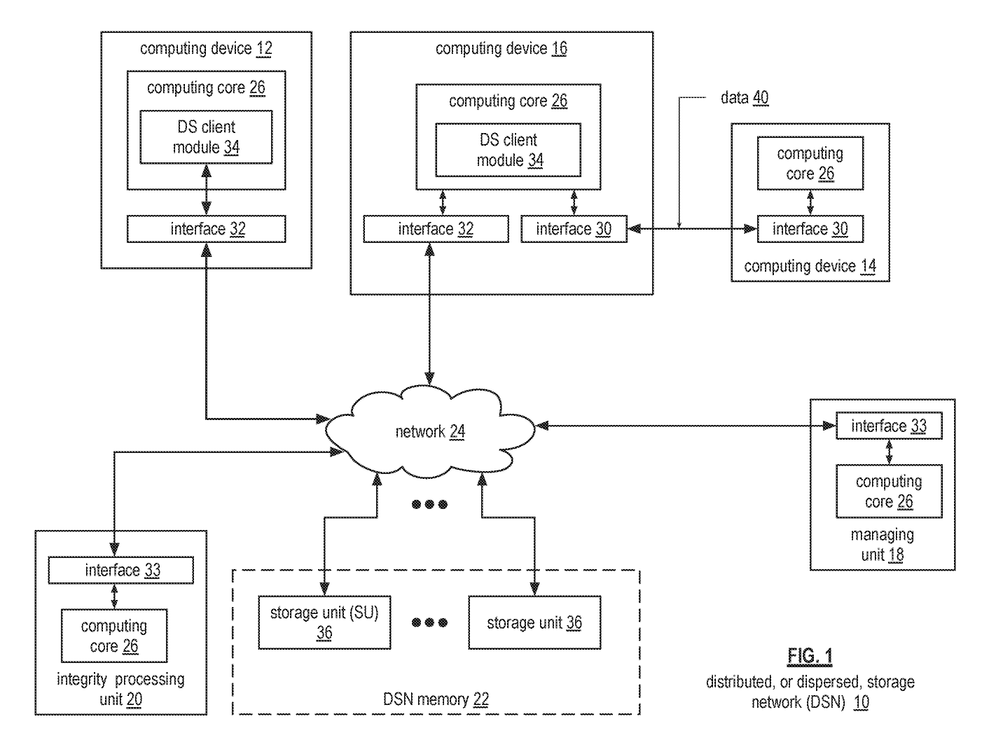

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

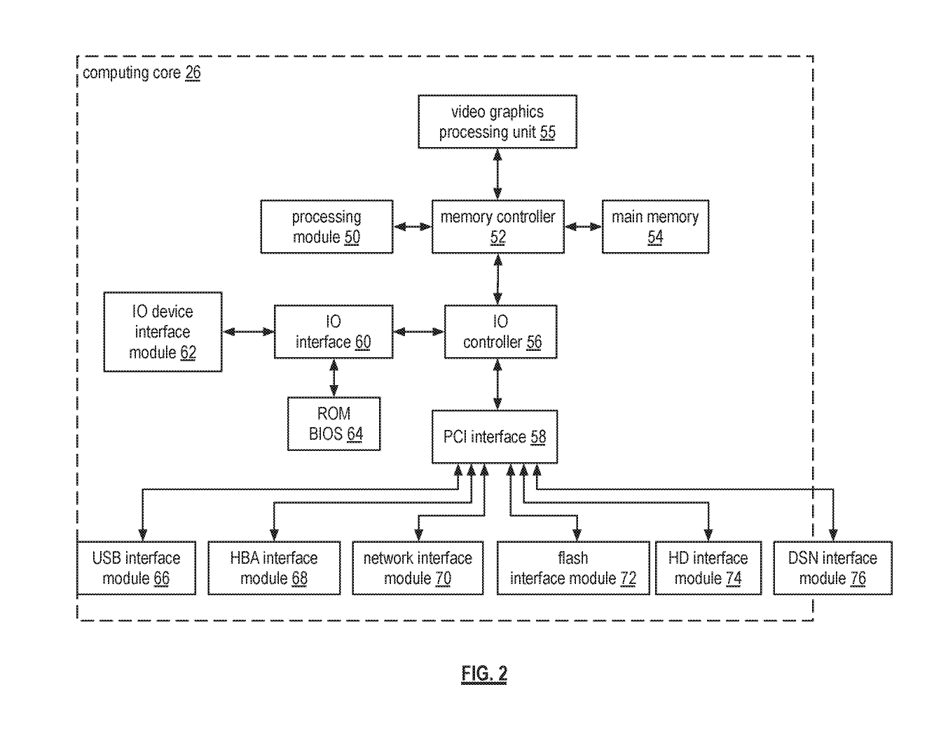

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSTN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSTN managing unit 18 tracks the number of times a user accesses a non-public vault and/or public vaults, which can be used to generate a per-access billing information. In another instance, the DSTN managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSTN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

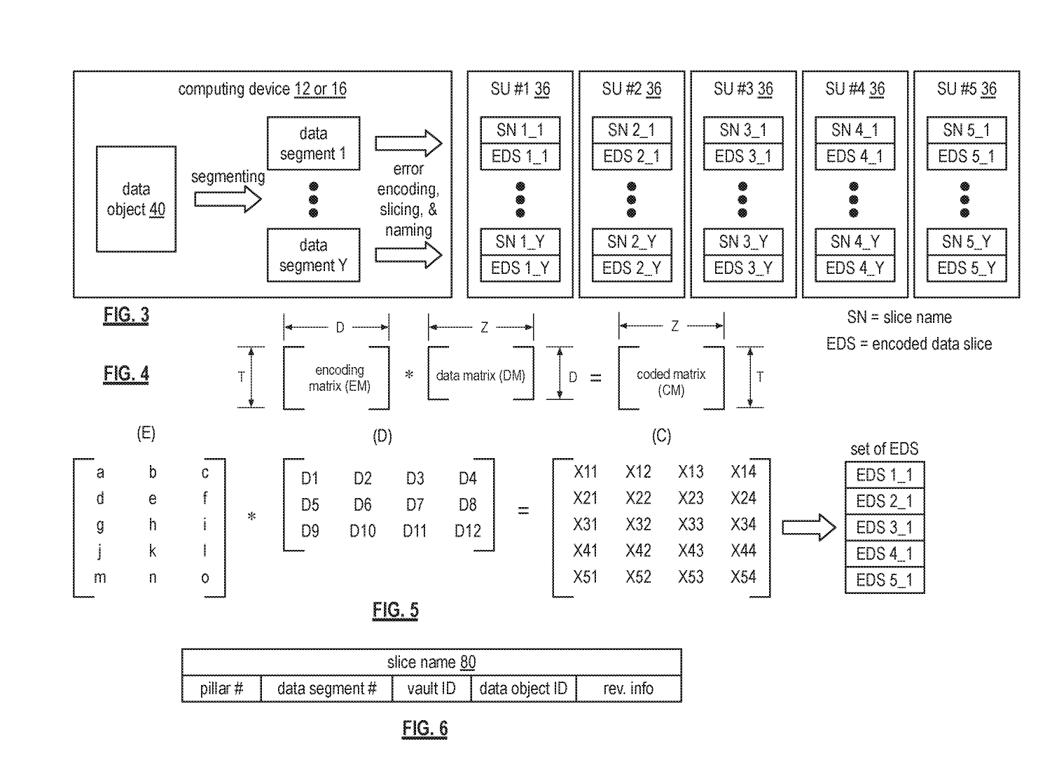

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

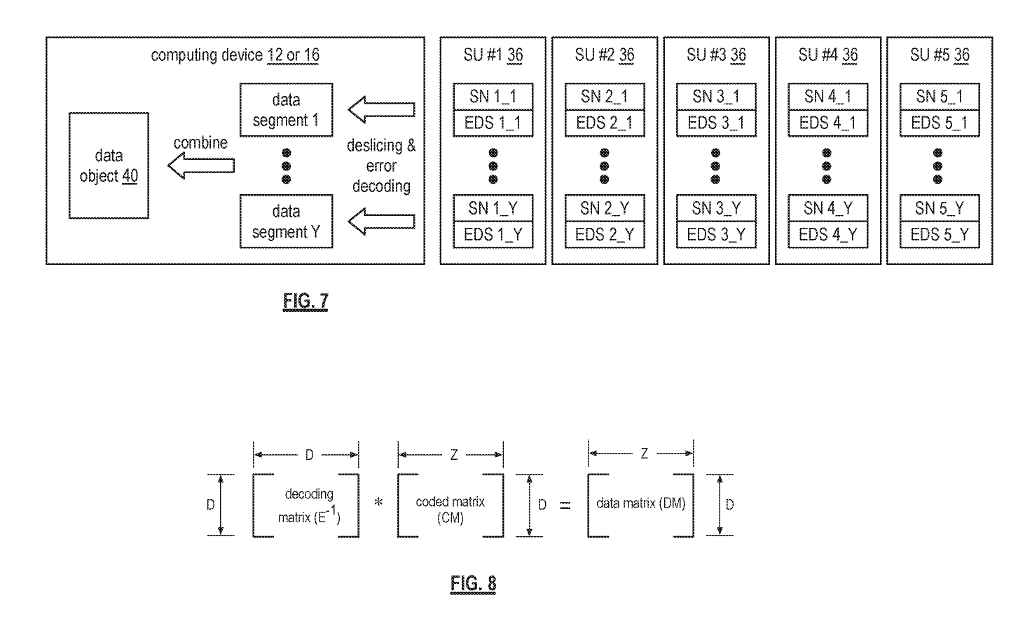

Returning to the discussion of FIG. 3, the computing device also creates a slice name (SN) for each encoded data slice (EDS) in the set of encoded data slices. A typical format for a slice name 60 is shown in FIG. 6. As shown, the slice name (SN) 60 includes a pillar number of the encoded data slice (e.g., one of 1−T), a data segment number (e.g., one of 1−Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

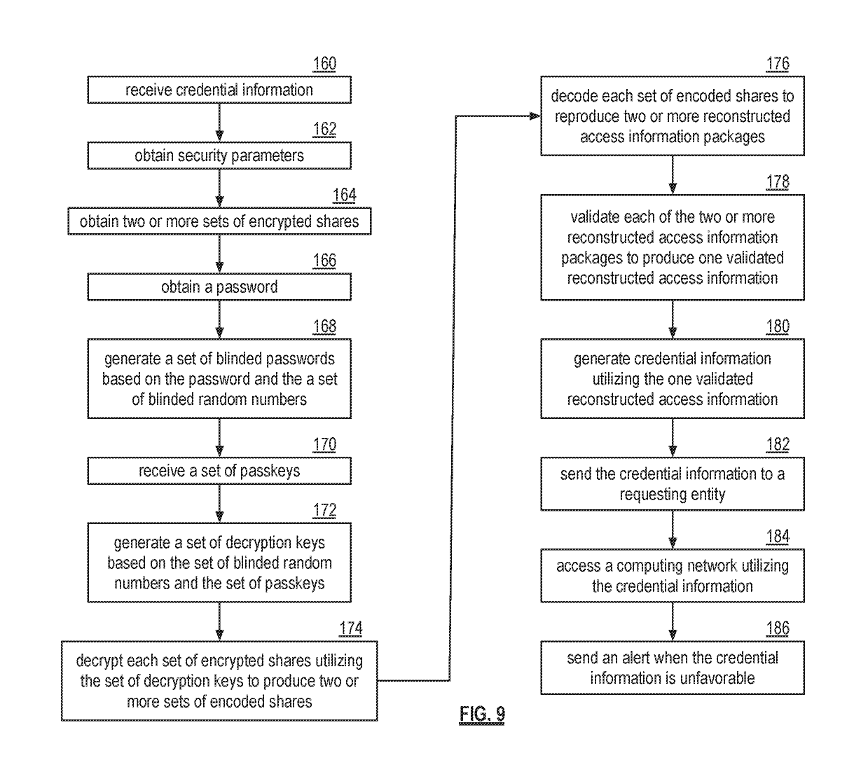

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

FIG. 9 is a flowchart illustrating an example of retrieving access information. The method begins at step 160 where a processing module (e.g., of a user device) receives a credential information request (e.g., from a user device process). The request includes at least one of a credential information request opcode, a credential information type indicator (e.g., a signing request, a key request, network access information request, access privileges request), and a certificate.

The method continues at step 162 where the processing module obtains security parameters. The security parameters may include one or more of a share number N, a value of security algorithm constant p (a prime number), a value of security algorithm constant q (a prime number), one or more shared secret algorithm parameters, an encryption algorithm indicator, a key generator function indicator, a key size, a random number generator function, a random number size, a hash function type indicator, a security package structure indicator, a number of passwords, and any other parameter to specify the operation of the storing of the access information package data. The obtaining may be based on one or more of retrieving the security parameters from a local memory, sending a query to a dispersed storage (DS) managing unit, and determining based on one or more of security requirements, a security status indicator, a user identifier (ID), a vault ID, a list, a table lookup, a predetermination, a message, and a command. For example, the processing module determines the security parameters based on a table lookup within a local memory corresponding requesting entity of the credential information request.

The method continues at step 164 where the processing module obtains two or more sets of encrypted shares. The obtaining includes at least one of retrieving the encrypted shares from a local memory (e.g., of the token device), retrieving the encrypted shares from a set of authentication servers, retrieving encrypted share slices from a dispersed storage network (DSN) memory and decoding the encrypted share slices to reproduce the set of encrypted shares. The method continues at step 166 where the processing module obtains a password of two or more passwords. The obtaining includes at least one of receiving the password from a user device input, retrieving the password from a memory, and receiving the password.

The method continues at step 168 where the processing module generates a set of blinded passwords based on the password and a set of blinded random numbers. The generating includes for each blinded random number of the set of blinded random numbers, transforming the password utilizing a mask generating function and the blinded random number to produce a blinded password of the set of blinded passwords. For example, the processing module generates a blinded password x based on a password pZ and a corresponding blinded random number bx in accordance with an expression blinded password x=((MGF(pZ))2)bx modulo p. The processing module generates the set of blinded random numbers by obtaining a set of base random numbers and expanding each base random number of the set of base random numbers based on security parameters to produce the set of blinded random numbers. For example, the processing module produces a blinded random number bx utilizing a random number generator function such that a bit length of the blinded random number bx is substantially the same as a bit length of one of a value of a security algorithm constant p and a bit length of a value of a security algorithm constant q. For instance, the processing module produces a blinded random number b3 that is 1,024 bits in length when the security algorithm constant p is 1,024 bits in length.

The method continues at step 170 where the processing module outputs a set of passkey requests to a set of authentication servers that includes the set of blinded passwords. The method continues at step 172 where the processing module receives a set of passkeys (e.g., from the user device). The method continues at step 174 where the processing module generates a set of decryption keys based on the set of blinded random numbers and the set of passkeys. The generating of the set of decryption keys includes generating a set of values based on the set of blinded random numbers and generating the set of decryption keys based on the set of values and the set of passkeys. The generating the set of values includes transforming the set of blinded random numbers utilizing a modulo function based on security parameters to produce the set of values. The generating the set of decryption keys based on the set of values and the set of passkeys includes transforming the passkey utilizing a modulo function based on security parameters and a corresponding value of the set of values to produce a decryption key of the set of decryption keys for each passkey of the set of passkeys. For example, the processing module generates a value vx of the set of values based on a blinded random number bx in accordance with the expression b*v modulo q=1, wherein q is a security constant of security parameters such that q=(p−1)/2. For instance, v=b̂(q−2) mod q, when q is prime (e.g., 8=7̂9 mod 11, 8*7 mod 11=1). The processing module generates a decryption key x based on a value vx and passkey x in accordance with an expression decryption key x=(passkey x)vx modulo p.

The method continues at step 176 where the processing module decrypts each set of the two or more sets of encrypted shares utilizing the set of decryption keys to produce two or more sets of encoded shares. The decryption is in accordance with a decryption algorithm and may be based on one or more of the security parameters, error coding dispersal storage function parameters, a user ID, a vault ID, a vault lookup, security requirements, a security status indicator, a message, and a command. The method continues at step 178 where the processing module decodes the two or more sets of encoded shares to reproduce two or more reconstructed access information packages. The decoding includes at least one of dispersed storage error decoding each set of encoded shares to produce each access information package and decoding each set of encoded shares utilizing a secret sharing function to reproduce the two or more reconstructed access information packages.

The method continues at step 180 where the processing module validates each of the two or more reconstructed access information packages to produce one validated reconstructed access information package. The validating includes comparing a calculated hash of access information of each reconstructed access information package to a retrieved access information hash digest of the reconstructed access information package. For example, the processing module determines that a first reconstructed access information package is valid when a comparison indicates that the calculated hash of the reconstructed access information is substantially the same as the retrieved access information hash digest.

The method continues at step 182 where the processing module generates credential information utilizing the one validated reconstructed access information package. For example, the processing module generates the credential information as a signature of a received certificate based on receiving a signing request credential information type indicator of the credential information request. The method continues at step 184 where the processing module sends the credential information to a requesting entity (e.g., to the user device process).

The method continues at step 186 where the processing module accesses a computing network utilizing the credential information. For example, the processing module sends a signature associated with the one validated reconstructed access information package to the computing network. In an instance, full access is granted by the computing network on receiving a signature associated with a non-duress scenario (e.g., a user entered a normal non-duress password). In another instance, limited access to fake information is granted by the computing network on receiving a signature associated with a duress scenario (e.g., a user entered a duress password). The method continues at step 188 where the processing module sends an alert when the credential information is unfavorable (e.g., an unfavorable flag is set in the one validated reconstructed access information package). The alert may indicate a duress scenario. The processing module sends the alert by outputting the alert to one or more of a second user device, a group of user devices, a security officer device, and a DS managing unit.

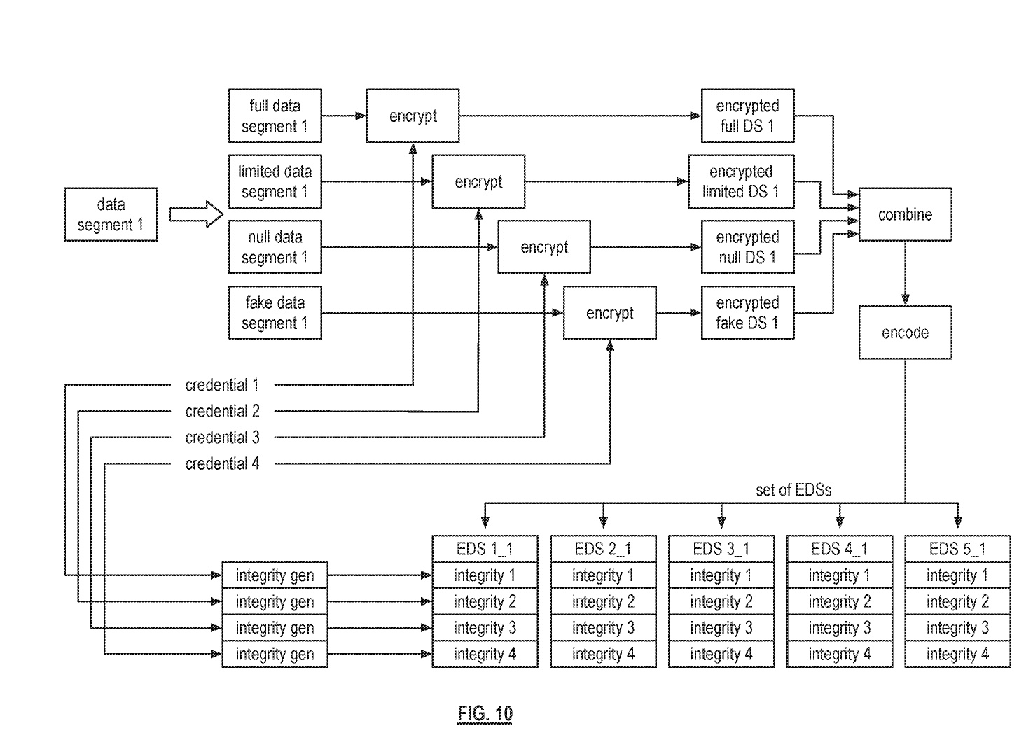

FIG. 10 is a schematic block diagram of an example of utilizing credentials in a DSN by a computing device. The computing device is one or more of computing device 12-16 of FIG. 1.

In an example of operation, the computing device generates a plurality of representations of data. The data includes one or more of a data segment, a data file, a data object, multiple data segments, multiple data files, and multiple data objects. A representation of the data includes a full version of the data, a limited version of the data, null data, and false data. For example, the data is a financial data file that includes information regarding a person. The information includes name, address, sex, age, birth date, social security number, banking information, etc. All such information is very private to the individual and needs to be held in the highest confidence.

For storage, the data file is divided into one or more data segments (for this example assume one data segment). In one representation of the data, it is the data itself (i.e., the full data regarding the person's financial data). In another representation of the data, it is limited data (e.g., for the financial data, it includes name, address, sex, age, but leaves out birth date, social security number, and banking information). In yet another representation of the data, it is null data (e.g., all zeros, all ones, or a random pattern of ones and/or zeros). In a further representation of the data, it is fake data. For example, fake data includes accurate information regarding name, address, sex, and age, but includes false information for birth date, social security number, and/or banking information.

For each representation of the data (which may be more or less than four representations), a corresponding access credential is created. For example, the access credential is an encryption key pair; thus, the first representation has a first encryption key pair, the second representation has a second encryption key pair, and so on. The computing device then encrypts the representations of the data using the access credentials to produce encrypted representations of the data. As shown, the full data segment is encrypted using the first credential to produce an encrypted full data segment (DS). The computing device then dispersed storage error encodes the encrypted representations of the data to produce one or more set of encoded data slices (EDSs).

The processing by the computing device continues with the computing device generating integrity data from the access credentials. For example, for a first access credential, the computing device performs a cyclic redundancy check (CRC), a deterministic function (e.g., a hash function, or other logical and/or mathematic function to produce a first integrity data. The computing device appends the integrity data to each encoded data slice of each of set to produce one or more sets of appended encoded data slices.

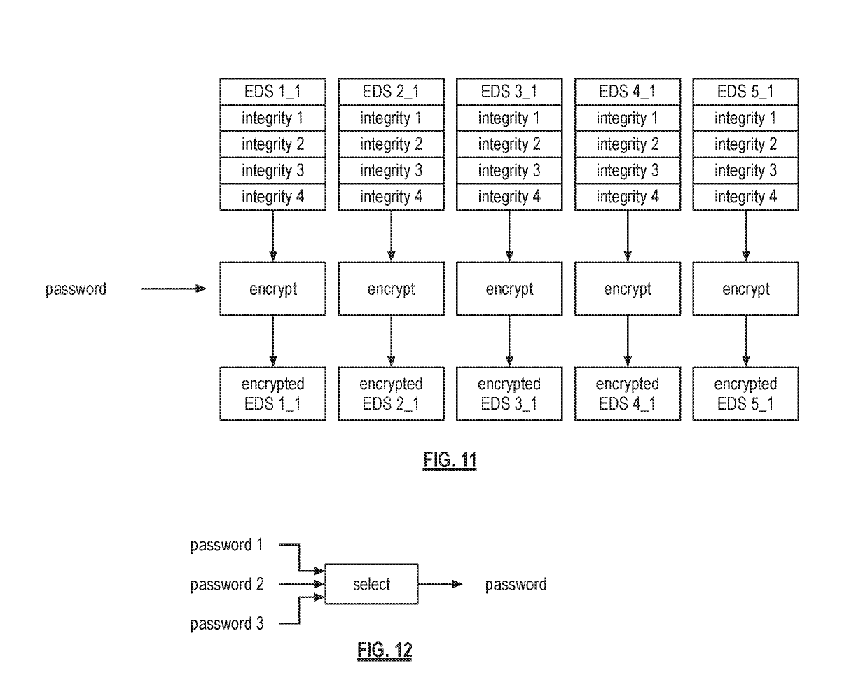

FIG. 11 is a schematic block diagram of another example of utilizing credentials in a DSN that continues the example of FIG. 10. In this diagram, the computing device encrypts the appended encoded data slices using a password to produce set(s) of encrypted encoded data slices. The computing device then sends the set(s) of encrypted encoded data slices to a set of storage units for storage therein.

By storing different representations of data using different access credentials, a person under duress to provide access credentials to sensitive data can provide a valid access credential without compromising key sensitive data. For example, the person under duress may provide the credential for the limited data for the fake data.

As a use example of the differing access credentials, assume that a device (e.g., a storage unit, a computing device, a system administrative device, a system managing device, etc.) receives a request to access data from a requesting device (e.g., the computing device discussed with reference to Figures and 10 and 11). The request is accompanied by an access credential. The device interprets the access credential to determine that the request has been submitted under duress (e.g., the person operating the requesting device is being forced to make the request). The device determines that the request is being submitted under duress in a variety of ways.

For example, the device determines that the access credential itself is indicative of duress. As another example, the device decrypts the recovered representations of the data using the access credential. When a valid decrypted representation of the data is not the full data, then the device infers the duress. When the device detects the duress, it sends an indication that the request has been submitted under duress to an authority device of the DSN.

In another example of use, the device or another device, recovers the encrypted representations of the data from at least a portion of the at least one set of encrypted encoded data slices (e.g., a threshold number of slices from each set). The device or the other device (e.g., a different computing device) utilizes the access credential to decrypt one of the encrypted representations of the data to recover a particular representation of the data. The device or the other device provides the particular representation of the data to the requesting entity. For example, the device will provide the full data segment when the first credential was used, provide the limited data segment when the second credential was used, the null data segment when the third credential was used, and provides the fake data segment when the fourth credential was used.

In yet another example, the device receives a request to retrieve the data from a requesting entity; the request is accompanied with an access credential. The device then recovers the encrypted representations of the data from at least a portion of the at least one set of encrypted encoded data slices (e.g., a threshold number of encoded data slices for each set). The device continues by decrypting the encrypted representations using the access credential to produce decrypted data representations. The device continues by selecting one of the decrypted data representations based on a desired decryption processing of the plurality of encrypted representations using the access credential (e.g., one decrypts properly, the others do not). The device continues by sending the one of the decrypted data representations to the requesting device.

FIG. 12 is a schematic block diagram of another example of utilizing credentials in a DSN. In this example, the password used to encrypt the encoded data slices is selected from a plurality of passwords. Each password may be associated with a corresponding credential, adding another layer of security and under duress indication.

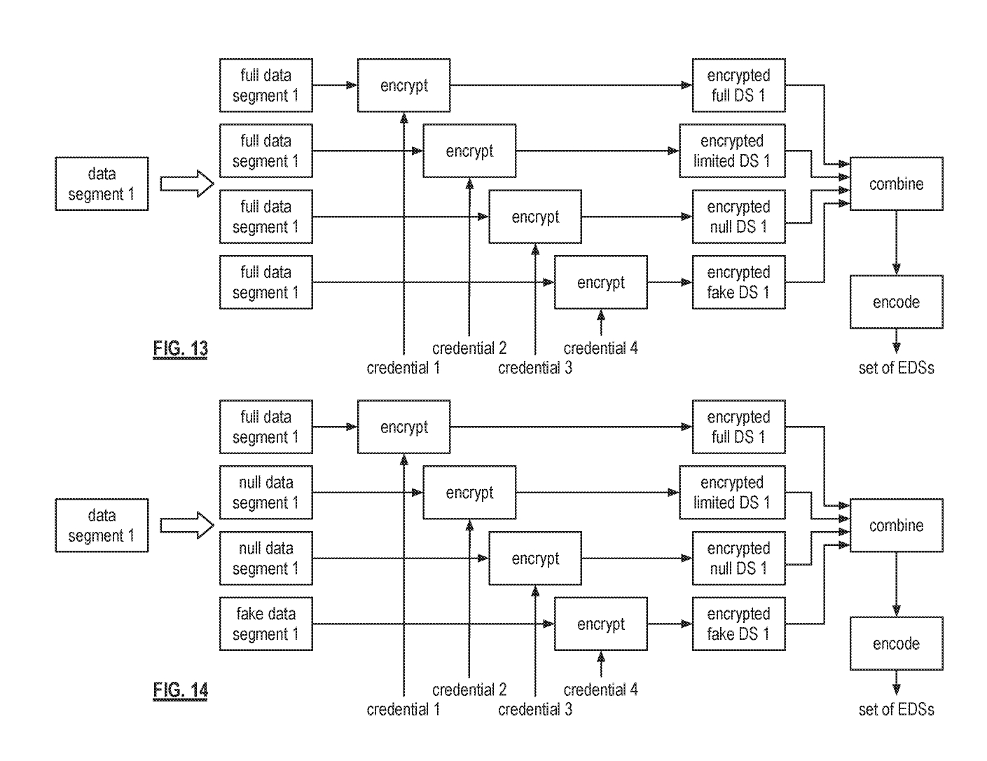

FIG. 13 is a schematic block diagram of another example of utilizing credentials in a DSN that is similar to FIG. 10 with the difference being that only the full data segment is processed. In this manner, no to very little information can be gained by analyzing the credentials as to which ones are used for less than full data. For example, assume that sensitive data (e.g., personal financial information) is processed as discussed with FIG. 10 and non-sensitive data (e.g., publicly available information) is processed as shown in FIG. 13. With four credentials (which could be more or less than four) being used, the data and the processing of it looks the same, thus no information regarding the less than full data and credentials thereof is revealed.

FIG. 14 is a schematic block diagram of another example of utilizing credentials in a DSN that is similar to FIG. 10 with the difference being there is no limited data segment and there are two null data segments. This too works to reduce the information that can be gained with respect to which credentials are used for which types of data segments. To further reduce credential-data detection, the credentials may be randomized. For example, the credentials 1-4 alternate in time for being used with the various data segment types. In particular, for a first time interval, the credentials are used as shown in FIG. 10; in a second time interval, credential 1 is used for the limited data segment, credential 2 is used for the null data segment, credential 3 is used for the fake data segment, and credential 4 is used for the full data segment.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
generating, by a computing device of a dispersed storage network (DSN), a first plurality of representations of data;
encrypting, by the computing device, the plurality of representations of the data using a plurality of access credentials to produce a plurality of encrypted representations of the data, wherein a first access credential of the plurality of access credentials is used to encrypt a first representation of the data of the plurality of representations of the data;
dispersed storage error encoding, by the computing device, the plurality of encrypted representations of the data to produce at least one set of encoded data slices;
generating, by the computing device, a plurality of integrity data from the plurality of access credentials, wherein a first integrity data of the plurality of integrity data is generated from the first access credential;
appending, by the computing device, the plurality of integrity data to each encoded data slice of each of the at least one set of encoded data slices to produce at least one set of appended encoded data slices;
encrypting, by the computing device, the at least one set of appended encoded data slices using a password to produce at least one set of encrypted encoded data slices; and
sending, by the computing device, the at least one set of encrypted encoded data slices to a set of storage units for storage therein.

2. The method of claim 1, wherein the plurality of representations of the data comprises two or more of:
a full version of the data;
a limited version of the data;
null data; and
false data.

3. The method of claim 1 further comprises:
receiving, by a device of the DSN, a request to retrieve the data from a requesting entity, wherein the request is accompanied with an access credential of the plurality of access credentials;
interpreting, by the device, the access credential to determine that the request has been submitted under duress; and
providing, by the device, an indication that the request has been submitted under duress to an authority device of the DSN.

4. The method of claim 3 further comprises:
recovering, by the device or another device, the plurality of encrypted representations of the data from at least a portion of the at least one set of encrypted encoded data slices;
utilizing, by the device of the other device, the access credential to decrypt one of the plurality of encrypted representations of the data to recover a particular representation of the data; and
providing, by the device or the other device, the particular representation of the data to the requesting entity.

5. The method of claim 3, wherein the interpreting the access credential to determine that the request has been submitted under duress comprises:
interpreting, by the device or the other device, integrity data of the plurality of integrity data that corresponds to the access credential, wherein the integrity data includes an indication that the access credential corresponds to a credential for use when an operator of the computing device is under duress to access data.

6. The method of claim 1 further comprises:
receiving, by a device of the DSN, a request to retrieve the data from a requesting entity, wherein the request is accompanied with an access credential of the plurality of access credentials;
recovering, by the device, the plurality of encrypted representations of the data from at least a portion of the at least one set of encrypted encoded data slices;
decrypting, by the device, the plurality of encrypted representations using the access credential to produce a plurality of decrypted data representations;
selecting, by the device, one of the plurality decrypted data representations based on a desired decryption processing of the plurality of encrypted representations using the access credential; and
sending, by the device, the one of the plurality decrypted data representations to the requesting device.

7. The method of claim 1 further comprises:
selecting, by the computing device, the password from a plurality of passwords.

8. A computer readable storage device comprises:
a first storage section that stores operational instructions that, when executed by a computing device of a dispersed storage network (DSN), causes the computing device to:
generate a first plurality of representations of data;
encrypt the plurality of representations of the data using a plurality of access credentials to produce a plurality of encrypted representations of the data, wherein a first access credential of the plurality of access credentials is used to encrypt a first representation of the data of the plurality of representations of the data;
dispersed storage error encode the plurality of encrypted representations of the data to produce at least one set of encoded data slices;
a second storage section that stores operational instructions that, when executed by the computing device, causes the computing device to:
generate a plurality of integrity data from the plurality of access credentials, wherein a first integrity data of the plurality of integrity data is generated from the first access credential;
append the plurality of integrity data to each encoded data slice of each of the at least one set of encoded data slices to produce at least one set of appended encoded data slices;
encrypt the at least one set of appended encoded data slices using a password to produce at least one set of encrypted encoded data slices; and
send the at least one set of encrypted encoded data slices to a set of storage units for storage therein.

9. The computer readable storage device of claim 8, wherein the plurality of representations of the data comprises two or more of:
a full version of the data;
a limited version of the data;
null data; and
false data.

10. The computer readable storage device of claim 8 further comprises:
a third storage section that stores operational instructions that, when executed by a device of the DSN, causes the device to:
receive a request to retrieve the data from a requesting entity, wherein the request is accompanied with an access credential of the plurality of access credentials;
interpret the access credential to determine that the request has been submitted under duress; and
provide an indication that the request has been submitted under duress to an authority device of the DSN.

11. The computer readable storage device of claim 10 further comprises:
a fourth storage section that stores operational instructions that, when executed by the device or another device of the DSN, causes the device or the other device to:
recover the plurality of encrypted representations of the data from at least a portion of the at least one set of encrypted encoded data slices;
utilize the access credential to decrypt one of the plurality of encrypted representations of the data to recover a particular representation of the data; and
provide the particular representation of the data to the requesting entity.

12. The computer readable storage device of claim 10, wherein the third storage section further stores operational instructions that, when executed by the device, causes the device to interpret the access credential to determine that the request has been submitted under duress by:
interpreting, by the device or the other device, integrity data of the plurality of integrity data that corresponds to the access credential, wherein the integrity data includes an indication that the access credential corresponds to a credential for use when an operator of the computing device is under duress to access data.

13. The computer readable storage device of claim 8 further comprises:
a third storage section that stores operational instructions that, when executed by a device of the DSN, causes the device to:
receive a request to retrieve the data from a requesting entity, wherein the request is accompanied with an access credential of the plurality of access credentials;
recover the plurality of encrypted representations of the data from at least a portion of the at least one set of encrypted encoded data slices;
decrypt the plurality of encrypted representations using the access credential to produce a plurality of decrypted data representations;
select one of the plurality decrypted data representations based on a desired decryption processing of the plurality of encrypted representations using the access credential; and
send the one of the plurality decrypted data representations to the requesting device.

14. The computer readable storage device of claim 8 further comprises:
a third storage section that stores operational instructions that, when executed by the computing device, causes the computing device to:
select the password from a plurality of passwords.
